(19) United States
(12) Patent Application Publication
(10) Pub. No.: US 2025/0373306 A1
(43) Pub. Date: Dec. 4, 2025

(54) CHANNEL STATE INFORMATION TRANSMISSION AND RECEPTION METHODS AND APPARATUSES AND COMMUNICATION SYSTEM

(71) Applicant: FUJITSU LIMITED, Kawasaki-shi (JP)

(72) Inventors: Qun ZHANG, Beijing (CN); Xin WANG, Beijing (CN); Gang SUN, Beijing (CN); Lei ZHANG, Beijing (CN)

(73) Assignee: FUJITSU LIMITED, Kawasaki-shi (JP)

(21) Appl. No.: 19/301,008

(22) Filed: Aug. 15, 2025

Related U.S. Application Data
(63) Continuation of application No. PCT/CN2023/076513, filed on Feb. 16, 2023.

(51) Int. Cl. H04B 7/06; H04W 24/10

(52) U.S. Cl. CPC H04B 7/0626; H04W 24/10

(57) ABSTRACT

Channel state information transmission and reception methods and apparatuses and a communication system. The transmission apparatus is applicable to a terminal equipment and includes: processor circuitry configured to generate first information of second channel state information (CSI) by using a second model when the terminal equipment determines that at least a part of first CSI needs to be omitted, the at least a part of the first CSI being generated based on a first model; and a first transmitter configured to transmit the second CSI and/or information on the second model to a network device.

### CROSS-REFERENCE TO RELATED APPLICATION

This application is a continuation application under 35 U.S.C. 111(a) of International Patent Application PCT/CN2023/076513 filed on Feb. 16, 2023, and designated the U.S., the entire contents of which are incorporated herein by reference.

### TECHNICAL FIELD

This disclosure relates to the field of communication technologies.

### BACKGROUND

Multiple-input multiple-output (MIMO) technology is one of the key technologies for 5G mobile communication. MIMO is able to provide higher channel capacity, but the realization of the benefit depends on whether accurate channel state information may be acquired.

In the MIMO technology, a terminal equipment measures spatial channels and feeds channel state information (CSI) back to a network device. According to the channel state information reported by the terminal equipment, the network device may select an appropriate precoding matrix suitable for the terminal equipment in performing downlink transmission, thereby reducing a probability of receiving bit errors of the terminal equipment as much as possible. A channel state information generation and feedback process may be summarized as follows. The network device transmits channel state information reference signals (CSI-RSs) to terminal equipments, and the terminal equipments estimate channels based on the received CSI-RSs to obtain estimation of a spatial channel matrix. The terminal equipments further utilize the estimated spatial channels to obtain CSI. In the New Radio (NR) technology, a feedback mode of CSI is implicit feedback, that is, the terminal equipments provide CSI in a form of recommending transmission parameters to the network device, the transmission parameters including a channel state information reference signal resource indicator (CQI), a precoding matrix indicator (PMI), a CSI-RS resource indicator (CRI), a synchronization signal block resource indicator (SSBRI), a layer indicator (LI), a rank indicator (RI), and physical layer RSRP (L1-RSRP), etc. A base station may directly use the parameters recommended by the terminal equipment to perform downlink transmission, or, it may not use the recommended parameters. In a frequency division duplex (FDD) system, for a downlink, when the network device uses information of downlink channels for precoding, the terminal equipment is needed to feed back the downlink channel state information to the network device via an uplink. However, as the information of downlink channels is proportional to the number of antennas of the network device, in a scenario of massive MIMO, the huge number of antennas of the network device will lead to a very large amount of feedback on the channel state information of the downlink channels. Enhanced codebooks (such as eType II codebooks) for downlink feedback has been designed in the Third Generation Partnership Project (3GPP), in which feedback amount of channel state information is reduced through frequency domain compression. However, for valuable uplink resources, there is still a need to further reduce the amount of uplink feedback.

With the development of artificial intelligence/machine learning (AI/ML) technologies, applying the AI/ML technologies to physical layers of wireless communication to solve difficulties in conventional methods has become a current technological direction.

FIG. 1 is a schematic diagram of CSI feedback based on AI/ML. An AI/ML module may include an AI/ML-based CSI generation portion and an AI/ML-based CSI reconstruction portion, wherein the AI/ML-based CSI generation portion includes an AI/ML model, the AI/ML model including an AI/ML encoder and a quantizer. In addition, and further including a preprocessing module. The AI/ML-based CSI reconstruction portion includes an AI/ML reconstruction model, the AI/ML reconstruction model including a quantizer and an AI/ML decoder, and further including a post-processing module.

As shown in FIG. 1, in operation 101, the terminal equipment side uses the AI/ML-based CSI generation portion to perform processing and obtains CSI, and the network device receives the CSI via air interface; and in operation 102, the network device uses the AI/ML-based CSI reconstruction portion to process the received CSI, and obtains recovered CSI.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Downlink transmission may have N transmission layers, N≥1. When CSI feedback is performed on the downlink transmission, a traditional codebook-based method may be used, or an AI/ML-based method may be used.

For example, in performing CSI feedback by using a traditional codebook-based method, a priority order is set for the CSI, and CSI is fed back in an order from high priority levels (priority reporting levels) (e.g. low values) to low priority levels (e.g., high values). The terminal equipment may omit the CSI in the above priority order (e.g. in a descending order of values of the priority levels). A method for setting the priority levels is: specifying a calculation method for values of the priority levels; and giving priority orders (such as priority orders given in Table 5.2.3-1 of 38.214) according to a method for setting priority levels.

In performing CSI feedback by using a traditional codebook-based method, omitting the CSI is performed on bits of a priority order level, that is, all bits of the priority order level are omitted.

For another example, in performing CSI feedback by using an AI/ML-based method, a priority order of the CSI may be divided according to transmission layers, and the priority order of CSI within each transmission layer may be divided according to bit positions. Omitting the CSI is performed on bits of a certain priority order level, that is, all bits of the priority order level are omitted.

It was found by the inventors of this disclosure that in the related art, when uplink resources are insufficient to transmit all contents in a certain CSI priority order level, even if the uplink resources are only 1 bit less than all the contents in the CSI priority order level, all contents in the CSI priority order level needs to be omitted (i.e. all bit sequences in the CSI priority order level need to be omitted), which will cause waste of uplink resources. In addition, for the CSI feedback in the AI/ML-based method, a method for truncating bits and positions of a bit sequence does not necessarily exhibit good performance for all CSI generated based on AI/ML, hence, omitting all contents in the CSI priority order level is sometimes not appropriate.

In order to solve at least one of the above problems or other similar problems, embodiments of this disclosure provide channel state information transmission and reception methods and apparatuses and a communication system. In a case where it is determined that at least a part of first channel state information (CSI) generated based on a first model needs to be omitted, a second model is used to generate first information of second CSI, thus, the first information of the second CSI may be transmitted, which makes it possible to fully use uplink resources to transmit CSI, thereby improving performances of 5G and/or 6G wireless communications.

According to a first aspect of the embodiments of this disclosure, there is provided a channel state information transmission apparatus, applicable to a terminal equipment, the apparatus including:
a first processor configured to generate first information of second channel state information (CSI) by using a second model when the terminal equipment determines that at least a part of first CSI needs to be omitted, the at least a part of the first CSI being generated based on a first model; and
a first transmitter configured to transmit the second CSI and/or information on the second model to a network device.

According to another aspect of the embodiments of this disclosure, there is provided a channel state information reception apparatus, applicable to a network device, the apparatus including:
a second receiver configured to receive information on a second model and/or second channel state information (CSI) transmitted by a terminal equipment,
wherein in a case where it is determined that at least a part of first channel state information (CSI) needs to be omitted, the terminal equipment generates first information of the second CSI by using the second model, the at least a part of the first CSI being generated based on a first model.

An advantage of the embodiments of this disclosure exists in that in a case where it is determined that at least a part of first channel state information (CSI) generated based on a first model needs to be omitted, a second model is used to generate first information of second CSI, thus, the first information of the second CSI may be transmitted, which makes it possible to fully use uplink resources to transmit CSI, thereby improving performances of 5G and/or 6G wireless communications.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of performing CSI feedback based on AI/ML;

FIG. 2 is a schematic diagram of a communication system of this disclosure;

FIG. 3 is a schematic diagram of the channel state information transmission method of the first aspect of this disclosure;

FIG. 4 is a schematic diagram of the channel state information reception method of the second aspect of this disclosure;

FIG. 5 is a schematic diagram of the channel state information transmission apparatus of the third aspect of this disclosure;

FIG. 6 is a schematic diagram of the channel state information reception apparatus of the fourth aspect of this disclosure;

FIG. 7 is a schematic diagram of the terminal equipment of the fifth aspect of this disclosure; and

FIG. 8 is a schematic diagram of the network device of the sixth aspect of this disclosure.

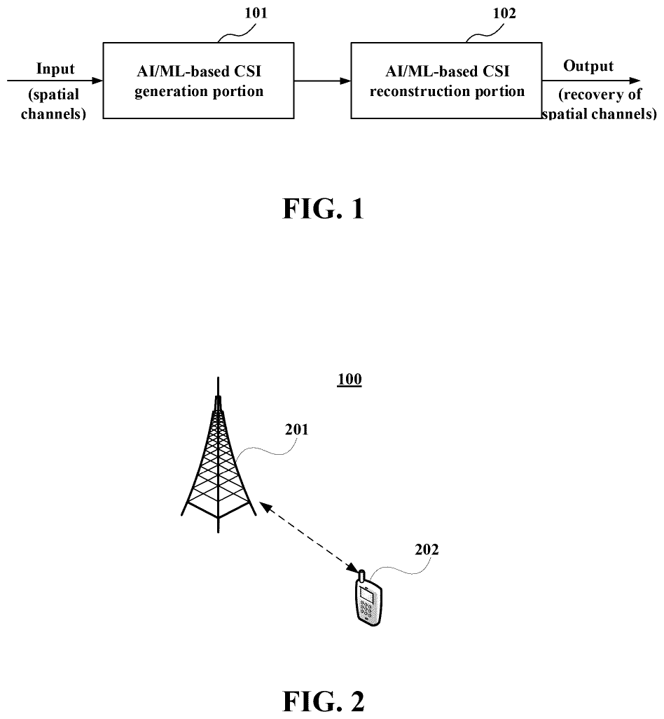

### DETAILED DESCRIPTION

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IOT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). High-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiment of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, and they are interchangeable.

In the embodiments described below, signaling transmitted by the network device to the terminal equipment may be transmitted via downlink control information (DCI), a media access control control element (MAC CE), and/or radio resource control (RRC) signaling.

In the following embodiments of this disclosure, there exists a pairing relationship between an AI/ML-based CSI generation portion and an AI/ML-based CSI reconstruction portion, the former being applicable to a terminal equipment side, and the latter being applicable to a network device side. If the terminal equipment uses an AI/ML-based CSI generation portion, the network device must use an AI/ML-based CSI reconstruction portion paired with the AI/ML-based CSI generation portion to successfully reconstruct channel information. And if the network device uses an AI/ML-based CSI reconstruction portion, the terminal equipment must use an AI/ML-based CSI generation portion paired with the AI/ML-based CSI reconstruction portion to successfully reconstruct channel information at the network device side.

The AI/ML-based CSI generation portion includes an AI/ML model, which may be used to generate one or more of precoding matrix information, a rank indicator (RI), a layer indicator (LI), a channel resource indicator (CRI), and a channel quality indicator (CQI). In addition, the RI, LI, CRI and CQI may not be generated by the AI/ML model. For example, the AI/ML-based CSI generation portion may further include more than one of a module generating an RI, a module generating an LI, a module generating a CRI, and a module generating a CQI. The AI/ML-based CSI generation portion may further include other modules, such as a module for truncating bit sequences.

The information of the AI/ML-based CSI generation portion may be composed of AI/ML model information and/or information of the module generating an RI and/or information of the module generating an LI and/or information of the module generating a CRI and/or information of the module generating a CQI and/or information of a module truncating a bit sequence and/or information of other functional modules (if any).

The AI/ML model may include three parts, a preprocessing module, an AI/ML encoder and a quantizer. Therefore, AI/ML model information may include preprocessing module information, AI/ML encoder information and quantizer information. For example, the AI/ML model information may be described by “preprocessing module #2, AI/ML encoder #4, quantizer #A”. In addition, the preprocessing module, AI/ML encoder and quantizer may be regarded as a whole to annotate the AI/ML model information, that is, the AI/ML model information may also be expressed as, for example, AI/ML model information #4, etc.

The AI/ML-based CSI reconstruction model of the AI/ML-based CSI reconstruction portion paired with the AI/ML-based CSI generation portion may also include three parts, a dequantizer, an AI/ML decoder, and a post-processing module. Therefore, the AI/ML reconstruction model information may include dequantizer information, AI/ML decoder information, and post-processing module information. For example, the AI/ML reconstruction model information may be described by “dequantizer #B, AI/ML decoder #1, post-processing module #2”. In addition, the AI/ML reconstruction model information may also be expressed as, for example, AI/ML reconstruction model #1, or AI/ML model #1 in brief, so as to express the pairing relationship with AI/ML model #1 in the AI/ML-based CSI generation portion.

The AI/ML model may also be composed of two parts (for example, it has no preprocessing module, or a preprocessing module is included in the AI/ML encoder and is regarded as a whole with the AI/ML encoder), that is, the AI/ML model includes an AI/ML encoder and a quantizer. At this point, the AI/ML model information may be composed of AI/ML encoder information and quantizer information. The AI/ML-based CSI reconstruction model of the AI/ML-based CSI reconstruction portion paired with the AI/ML model may also consist of two parts, a quantizer and an AI/ML decoder. At this point, the AI/ML reconstruction model information consists of quantizer information and AI/ML decoder information. The preprocessing module may be included in the AI/ML encoder, or may not be included in the AI/ML encoder. The post-processing module may be included in the AI/ML decoder or may not be included in the AI/ML decoder.

The AI/ML model may also be composed of one part, that is, the AI/ML encoder and quantizer are regarded as a whole (for example, the AI/ML encoder and quantizer are inseparable and cannot be freely combined), and the AI/ML encoder may or may not include a preprocessing module. At this point, the AI/ML model information consists of one part only, for example, the AI/ML model information is AI/ML model #5. The AI/ML reconstruction model may also be composed of one part, that is, the quantizer and AI/ML decoder are regarded as a whole (for example, the AI/ML decoder and quantizer are inseparable and cannot be freely combined), and the AI/ML decoder may or may not include a post-processing module. At this point, the AI/ML reconstruction model information consists of one part only, for example, the AI/ML reconstruction model information is AI/ML reconstruction model #5, or AI/ML model #5 in brief, so as to express the pairing relationship with AI/ML model #5 in the AI/ML-based CSI generation portion.

In performing CSI feedback by using a traditional codebook-based method, the set priority order of part 2 of the CSI may be represented in Table 1 below, which is, for example, Table 5.2.3-1 of 38.214.

TABLE 1
Table 5.2.3-1: Priority reporting levels for Part 2 CSI
Priority 0:
For CSI reports 1 to N_{Rep}, Group 0 CSI for CSI reports
configured as ‘typeII-r16’, ‘typeII-PortSelection-r16’ or
‘typeII-PortSelection-r17’; Part 2 wideband CSI for CSI
reports configured otherwise
Priority 1:
Group 1 CSI for CSI report 1, if configured as ‘typeII-
r16’, ‘typeII-PortSelection-r16’ or ‘typeII-PortSelection-
r17’; Part 2 subband CSI of even subbands for CSI report
1, if configured otherwise
Priority 2:
Group 2 CSI for CSI report 1, if configured as ‘typeII-
r16’, ‘typeII-PortSelection-r16’ or ‘typeII-PortSelection-
r17’; Part 2 subband CSI of odd subbands for CSI report
1, if configured otherwise
Priority 3:
Group 1 CSI for CSI report 2, if configured as ‘typeII-
r16’, ‘typeII-PortSelection-r16’ or ‘typeII-PortSelection-
r17’; Part 2 subband CSI of even subbands for CSI report
2, if configured otherwise
Priority 4:
Group 2 CSI for CSI report 2, if configured as ‘typeII-
r16’, ‘typeII-PortSelection-r16’ or ‘typeII-PortSelection-
r17’. Part 2 subband CSI of odd subbands for CSI report
2, if configured otherwise
.
.
.
Priority 2N_{Rep} − 1:
Group 1 CSI for CSI report N_{Rep}, if configured as
‘typeII-r16’, ‘typeII-PortSelection-r16’ or ‘typeII-
PortSelection-r17’; Part 2 subband CSI of even subbands
for CSI report N_{Rep}, if configured otherwise
Priority 2N_{Rep}:
Group 2 CSI for CSI report N_{Rep}, if configured as
‘typeII-r16’, ‘typeII-PortSelection-r16’ or ‘typeII-
PortSelection-r17’; Part 2 subband CSI of odd subbands
for CSI report N_{Rep}, if configured otherwise

For another example, in performing CSI feedback by using an AI/ML-based method, the priority order of the CSI may be represented in Table 2 or Table 3 below.

TABLE 2

| | #1 | #2 | #3 |
|---|---|---|---|
| Priority order | An a₁-th bit of a first layer | A b₁-th bit of a first | A c₁-th bit of a first layer of |
| level 1 | of part 2 of CSI in CSI | layer of part 2 of | part 2 of CSI in CSI report 1 |
| | report 1 | CSI in CSI report 1 | |
| Priority order | Other bits of a first layer of | A b₂-th bit of a | Other bits of a first layer of |
| level 2 | part 2 of CSI in CSI report | second layer of part | part 2 of CSI in CSI report 1 |
| | 1 (it is possible that the | 2 of CSI in CSI | (it is possible that the other |
| | other bits may not exist, | report 1 | bits may not exist, and at this |
| | and at this time, the | | time, the priority order level |
| | priority order level does | | does not exist) |
| | not exist) | | |
| Priority order | An a₂-th bit of a second | Other bits of a first | A c₂-th bit of a second layer |
| level 3 | layer of part 2 of CSI in | layer of part 2 of | of part 2 of CSI in CSI report |
| | CSI report 1 | CSI in CSI report 1 | 1 |
| | | (it is possible that | |
| | | the other bits may | |
| | | not exist, and at this | |
| | | time, the priority | |
| | | order level does not | |
| | | exist) | |
| Priority order | An a₃-th bit of a third layer | A b₃-th bit of a third | A c₃-th bit of a third layer of |
| level 4 | of part 2 of CSI in CSI | layer of part 2 of | part 2 of CSI in CSI report 1 |
| | report 1 | CSI in CSI report 1 | |
| Priority order | Other bits of a second | Other bits of a | Other bits of a second layer |
| level 5 | layer of part 2 of CSI in | second layer of part | of part 2 of CSI in CSI report |
| | CSI report 1 (it is possible | 2 of CSI in CSI | 1 (it is possible that the other |
| | that the other bits may not | report 1 (it is | bits may not exist, and at this |
| | exist, and at this time, the | possible that the | time, the priority order level |
| | priority order level does | other bits may not | does not exist) |
| | not exist) | exist, and at this | |
| | | time, the priority | |
| | | order level does not | |
| | | exist) | |
| Priority order | An a₄-th bit of a fourth | A b₄-th bit of a | Other bits of a third layer of |
| level 6 | layer of part 2 of CSI in | fourth layer of part | part 2 of CSI in CSI report 1 |
| | CSI report 1 | 2 of CSI in CSI | (it is possible that the other |
| | | report 1 | bits may not exist, and at this |
| | | | time, the priority order level |
| | | | does not exist) |
| Priority order | Other bits of a third layer | Other bits of a third | A c₄-th bit of a fourth layer |
| level 7 | of part 2 of CSI in CSI | layer of part 2 of | of part 2 of CSI in CSI report |
| | report 1 (it is possible that | CSI in CSI report 1 | 1 |
| | the other bits may not | (it is possible that | |
| | exist, and at this time, the | the other bits may | |
| | priority order level does | not exist, and at this | |
| | not exist) | time, the priority | |
| | | order level does not | |
| | | exist) | |
| Priority order | Other bits of a fourth layer | Other bits of a | Other bits of a fourth layer |
| level 8 | of part 2 of CSI in CSI | fourth layer of part | of part 2 of CSI in CSI report |
| | report 1 (it is possible that | 2 of CSI in CSI | 1 (it is possible that the other |
| | the other bits may not | report 1 (it is | bits may not exist, and at this |
| | exist, and at this time, the | possible that the | time, the priority order level |
| | priority order level does | other bits may not | does not exist) |
| | not exist) | exist, and at this | |
| | | time, the priority | |
| | | order level does not | |
| | | exist) | |
| Priority order | An a₅-th bit of a first layer | A b₅-th bit of a first | A c₅-th bit of a first layer of |
| level 9 | of part 2 of CSI in CSI | layer of part 2 of | part 2 of CSI in CSI report 2 |
| | report 2 | CSI in CSI report 2 | |
| Priority order | Other bits of a first layer of | A b₆-th bit of a | Other bits of a first layer of |
| level 10 | part 2 of CSI in CSI report | second layer of part | part 2 of CSI in CSI report 2 |
| | 2 (it is possible that the | 2 of CSI in CSI | (it is possible that the other |
| | other bits may not exist, | report 2 | bits may not exist, and at this |
| | and at this time, the | | time, the priority order level |
| | priority order level does | | does not exist) |
| | not exist) | | |
| Priority order | An a₆-th bit of a second | Other bits of a first | A c₆-th bit of a second layer |
| level 11 | layer of part 2 of CSI in | layer of part 2 of | of part 2 of CSI in CSI report |
| | CSI report 2 | CSI in CSI report 2 | 2 |
| | | (it is possible that | |
| | | the other bits may | |
| | | not exist, and at this | |
| | | time, the priority | |
| | | order level does not | |
| | | exist) | |
| Priority order | An a₇-th bit of a third layer | A b₇-th bit of a third | A c₇-th bit of a third layer of |
| level 12 | of part 2 of CSI in CSI | layer of part 2 of | part 2 of CSI in CSI report 2 |
| | report 2 | CSI in CSI report 2 | |
| Priority order | Other bits of a second | Other bits of a | Other bits of a second layer |
| level 13 | layer of part 2 of CSI in | second layer of part | of part 2 of CSI in CSI report |
| | CSI report 2 (it is possible | 2 of CSI in CSI | 2 (it is possible that the other |
| | that the other bits may not | report 2 (it is | bits may not exist, and at this |
| | exist, and at this time, the | possible that the | time, the priority order level |
| | priority order level does | other bits may not | does not exist) |
| | not exist) | exist, and at this | |
| | | time, the priority | |
| | | order level does not | |
| | | exist) | |
| Priority order | An a₈-th bit of a fourth | A b₈-th bit of a | Other bits of a third layer of |
| level 14 | layer of part 2 of CSI in | fourth layer of part | part 2 of CSI in CSI report 2 |
| | CSI report 2 | 2 of CSI in CSI | (it is possible that the other |
| | | report 2 | bits may not exist, and at this |
| | | | time, the priority order level |
| | | | does not exist) |
| Priority order | Other bits of a third layer | Other bits of a third | A c₈-th bit of a fourth layer |
| level 15 | of part 2 of CSI in CSI | layer of part 2 of | of part 2 of CSI in CSI report |
| | report 2 (it is possible that | CSI in CSI report 2 | 2 |
| | the other bits may not | (it is possible that | |
| | exist, and at this time, the | the other bits may | |
| | priority order level does | not exist, and at this | |
| | not exist) | time, the priority | |
| | | order level does not | |
| | | exist) | |
| Priority order | Other bits of a fourth layer | Other bits of a | Other bits of a fourth layer |
| level 16 | of part 2 of CSI in CSI | fourth layer of part | of part 2 of CSI in CSI report |
| | report 2 (it is possible that | 2 of CSI in CSI | 2 (it is possible that the other |
| | the other bits may not | report 2 (it is | bits may not exist, and at this |
| | exist, and at this time, the | possible that the | time, the priority order level |
| | priority order level does | other bits may not | does not exist) |
| | not exist) | exist, and at this | |
| | | time, the priority | |
| | | order level does not | |
| | | exist) | |
| Priority order | An a₄-th bit of a first layer | A b₉-th bit of a first | A c₉-th bit of a first layer of |
| level 17 | of part 2 of CSI in CSI | layer of part 2 of | part 2 of CSI in CSI report 3 |
| | report 3 | CSI in CSI report 3 | |
| Priority order | Other bits of a first layer of | A b₁₀-th bit of a | Other bits of a first layer of |
| level 18 | part 2 of CSI in CSI report | second layer of part | part 2 of CSI in CSI report 3 |
| | 3 (it is possible that the | 2 of CSI in CSI | (it is possible that the other |
| | other bits may not exist, | report 3 | bits may not exist, and at this |
| | and at this time, the | | time, the priority order level |
| | priority order level does | | does not exist) |
| | not exist) | | |
| Priority order | An a₁₀-th bit of a second | Other bits of a first | A c₁₀-th bit of a second layer |
| level 19 | layer of part 2 of CSI in | layer of part 2 of | of part 2 of CSI in CSI report |
| | CSI report 3 | CSI in CSI report 3 | 3 |
| | | (it is possible that | |
| | | the other bits may | |
| | | not exist, and at this | |
| | | time, the priority | |
| | | order level does not | |
| | | exist) | |
| Priority order | An a₁₁-th bit of a third | A b₁₁-th bit of a | A c₁₁-th bit of a third layer of |
| level 20 | layer of part 2 of CSI in | third layer of part 2 | part 2 of CSI in CSI report 3 |
| | CSI report 3 | of CSI in CSI report | |
| | | 3 | |
| Priority order | Other bits of a second | Other bits of a | Other bits of a second layer |
| level 21 | layer of part 2 of CSI in | second layer of part | of part 2 of CSI in CSI report |
| | CSI report 3 (it is possible | 2 of CSI in CSI | 3 (it is possible that the other |
| | that the other bits may not | report 3 (it is | bits may not exist, and at this |
| | exist, and at this time, the | possible that the | time, the priority order level |
| | priority order level does | other bits may not | does not exist) |
| | not exist) | exist, and at this | |
| | | time, the priority | |
| | | order level does not | |
| | | exist) | |
| Priority order | An a₁₂-th bit of a fourth | A b₁₂-th bit of a | Other bits of a third layer of |
| level 22 | layer of part 2 of CSI in | fourth layer of part | part 2 of CSI in CSI report 3 |
| | CSI report 3 | 2 of CSI in CSI | (it is possible that the other |
| | | report 3 | bits may not exist, and at this |
| | | | time, the priority order level |
| | | | does not exist) |
| Priority order | Other bits of a third layer | Other bits of a third | A c₁₂-th bit of a second layer |
| level 23 | of part 2 of CSI in CSI | layer of part 2 of | of part 2 of CSI in CSI report |
| | report 3 (it is possible that | CSI in CSI report 3 | 3 |
| | the other bits may not | (it is possible that | |
| | exist, and at this time, the | the other bits may | |
| | priority order level does | not exist, and at this | |
| | not exist) | time, the priority | |
| | | order level does not | |
| | | exist) | |
| Priority order | Other bits of a fourth layer | Other bits of a | Other bits of a fourth layer |
| level 24 | of part 2 of CSI in CSI | fourth layer of part | of part 2 of CSI in CSI report |
| | report 3 (it is possible that | 2 of CSI in CSI | 3 (it is possible that the other |
| | the other bits may not | report 3 (it is | bits may not exist, and at this |
| | exist, and at this time, the | possible that the | time, the priority order level |
| | priority order level does | other bits may not | does not exist) |
| | not exist) | exist, and at this | |
| | | time, the priority | |
| | | order level does not | |
| | | exist) | |

TABLE 3

| | #1 | #2 | #3 |
|---|---|---|---|
| Priority order level 0 | An a₁-th, a₅-th and a₉-th bits of a | May be other | May be other |
| | first layer of part 2 of CSI in CSI | combinations | combinations |
| | reports 1-3 | | |
| Priority order level 1 | Other bits of a first layer of part 2 of | | |
| | CSI in CSI report 1 (it is possible | | |
| | that the other bits may not exist, and | | |
| | at this time, the priority order level | | |
| | does not exist) | | |
| Priority order level 2 | An a₂-th bit of a second layer of part | | |
| | 2 of CSI in CSI report 1 | | |
| Priority order level 3 | An a₃-th bit of a third layer of part 2 | | |
| | of CSI in CSI report 1 | | |
| Priority order level 4 | Other bits of a second layer of part 2 | | |
| | of CSI in CSI report 3 (it is possible | | |
| | that the other bits may not exist, and | | |
| | at this time, the priority order level | | |
| | does not exist) | | |
| Priority order level 5 | An a₄-th bit of a fourth layer of part | | |
| | 2 of CSI in CSI report 1 | | |
| Priority order level 6 | Other bits of a third layer of part 2 | | |
| | of CSI in CSI report 1 (it is possible | | |
| | that the other bits may not exist, and | | |
| | at this time, the priority order level | | |
| | does not exist) | | |
| Priority order level 7 | Other bits of a fourth layer of part 2 | | |
| | of CSI in CSI report 1 (it is possible | | |
| | that the other bits may not exist, and | | |
| | at this time, the priority order level | | |
| | does not exist) | | |
| Priority order level 8 | Other bits of a first layer of part 2 of | | |
| | CSI in CSI report 2 (it is possible | | |
| | that the other bits may not exist, and | | |
| | at this time, the priority order level | | |
| | does not exist) | | |
| Priority order level 9 | An a₆-th bit of a second layer of part | | |
| | 2 of CSI in CSI report 2 | | |
| Priority order level | An a₇-th bit of a third layer of part 2 | | |
| 10 | of CSI in CSI report 2 | | |
| Priority order level | Other bits of a second layer of part 2 | | |
| 11 | of CSI in CSI report 2 (it is possible | | |
| | that the other bits may not exist, and | | |
| | at this time, the priority order level | | |
| | does not exist) | | |
| Priority order level | An a₈-th bit of a fourth layer of part | | |
| 12 | 2 of CSI in CSI report 2 | | |
| Priority order level | Other bits of a third layer of part 2 | | |
| 13 | of CSI in CSI report 2 (it is possible | | |
| | that the other bits may not exist, and | | |
| | at this time, the priority order level | | |
| | does not exist) | | |
| Priority order level | Other bits of a fourth layer of part 2 | | |
| 14 | of CSI in CSI report 2 (it is possible | | |
| | that the other bits may not exist, and | | |
| | at this time, the priority order level | | |
| | does not exist) | | |
| Priority order level | Other bits of a first layer of part 2 of | | |
| 15 | CSI in CSI report 3 (it is possible | | |
| | that the other bits may not exist, and | | |
| | at this time, the priority order level | | |
| | does not exist) | | |
| Priority order level | An a₁₀-th bit of a second layer of | | |
| 16 | part 2 of CSI in CSI report 3 | | |
| Priority order level | An a₁₁-th bit of a third layer of part | | |
| 17 | 2 of CSI in CSI report 3 | | |
| Priority order level | Other bits of a second layer of part 2 | | |
| 18 | of CSI in CSI report 3 (it is possible | | |
| | that the other bits may not exist, and | | |
| | at this time, the priority order level | | |
| | does not exist) | | |
| Priority order level | An a₁₂-th bit of a fourth layer of part | | |
| 19 | 2 of CSI in CSI report 3 | | |
| Priority order level | Other bits of a third layer of part 2 | | |
| 20 | of CSI in CSI report 3 (it is possible | | |
| | that the other bits may not exist, and | | |
| | at this time, the priority order level | | |
| | does not exist) | | |
| Priority order level | Other bits of a fourth layer of part 2 | | |
| 21 | of CSI in CSI report 3 (it is possible | | |
| | that the other bits may not exist, and | | |
| | at this time, the priority order level | | |
| | does not exist) | | |

In Table 1, Table 2 and various embodiments of this disclosure, “a priority order level N (N is a non-negative integer, for example, N is 1, 2, 3, etc.)” may also be referred to as “a priority order N”, or “a priority level N”, or “a priority reporting level N”, or “a value N of a priority order”, etc.

In various embodiments of this disclosure, reporting may refer to an action of transmitting information by the terminal equipment to the network device. For example, reporting CSI by the terminal equipment may refer to transmitting CSI by the terminal equipment to the network device. Embodiments of a first aspect

The embodiments of the first aspect provide a channel state information (CSI) transmission method, applicable to a terminal equipment, the terminal equipment being able to communicate with a network device. In the following description, the terminal equipment may be, for example, the terminal equipment 202 in FIG. 2, and the network device may be, for example, the network device 201 in FIG. 2.

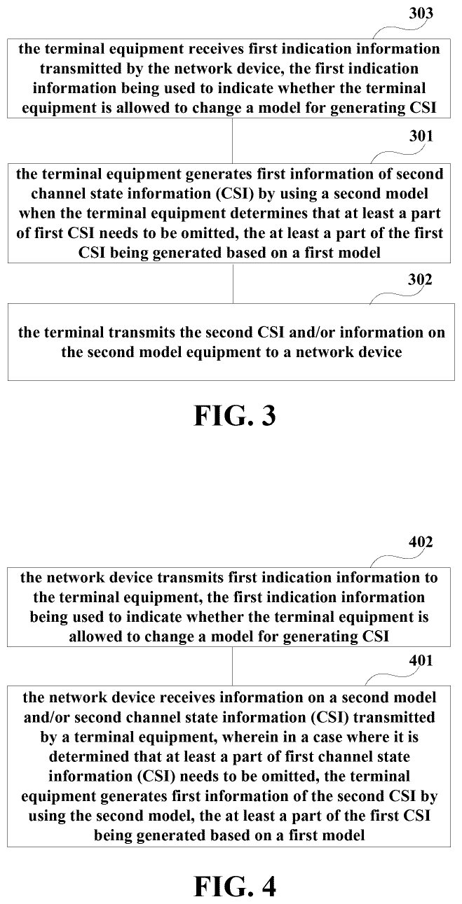

FIG. 3 is a schematic diagram of the channel state information (CSI) transmission method of the first aspect of this disclosure. As shown in FIG. 3, the method includes:
operation 301: the terminal equipment generates first information of second channel state information (CSI) by using a second model when the terminal equipment determines that at least a part of first CSI needs to be omitted, the at least a part of the first CSI being generated based on a first model; and
operation 302: the terminal equipment transmits the second CSI and/or information on the second model to a network device.

According to the embodiment of the first aspect of this disclosure, in a case where it is determined that at least a part of first channel state information (CSI) generated based on a first model needs to be omitted, a second model is used to generate first information of second CSI, thus, the first information of the second CSI may be transmitted, which makes it possible to fully use uplink resources to transmit CSI, thereby improving performances of 5G and/or 6G wireless communications.

In operation 301, the terminal equipment may determine whether to omit at least a part of the first channel state information (CSI) based on an omission criteria. The omission criterion is, for example, omitting according to a priority order of CSI. Defined forms of priority order levels in the priority order of the CSI priority may be, for example, the forms shown in Table 1 or Table 2 or Table 3, or, or may be in other forms.

The priority order of the CSI may be specified in a protocol, and/or, the priority order of the CSI may be specified in configuration information transmitted by the network device to the terminal, and/or, the terminal equipment receives selection instruction information transmitted by the network device, the selection instruction information instructing the terminal equipment to select an omission criterion from multiple candidate omission criteria and transmit information on the selected omission criterion to the network device, and/or, may be agreed upon between the terminal equipment and the network device.

In some embodiments, the first model may be a model generating CSI based on an artificial intelligence model, or a model generating CSI in a codebook-based method. The second model may be a model generating CSI based on an artificial intelligence model, or a model generating CSI in a codebook-based method. The first model and the second model may be different.

In some embodiments of operation 301, the terminal equipment may use the second model to a transmission layer to be omitted to generate the first information of the second CSI, wherein a bitwidth of the first information does not exceed a difference between a bitwidth output by the first model and the number of bits of the transmission layer needing to be omitted. Thus, uplink resources of the transmission layer may transmit all contents of the first information of the second CSI.

The first information of the second CSI includes precoding matrix information, and/or a layer indicator (LI), and/or at least a part of information of a channel quality indicator (CQI).

In some embodiments, the information on the second model includes: information on the artificial intelligence model of the second model; and/or information on the quantizer model of the second model; and/or information on the adaptation layer model of the second model; and/or configuration information of the codebook of the second model.

In some embodiments, the terminal equipment obtains the second model according to available uplink resources.

In some embodiments, a method for obtaining the second model by the terminal equipment may be changing the first model, such as,
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.

For changing the AI model of the first model, for example, when the AI/ML encoder and quantizer of the AI model cannot be separated, the AI model may be changed as a whole, or when the AI/ML encoder and quantizer of the AI model may be separated and combined with each other, the AI/ML encoder and/or quantizer of the AI model may be changed. The information on the second model is information on the AI/ML model, such as AI/ML model #1.

For changing the quantizer model of the first model, for example, when the AI/ML encoder and quantizer of the AI model of the first model may be separated and combined with each other, the quantizer of the AI model may be changed. The information on the second model is, for example, information on the quantizer model, such as quantizer model #2.

For adding an adaptation layer to the first model or reducing the adaptation layer of the first model or changing the adaptation layer of the first model, for example, adaptation layers appear in pairs at the terminal equipment side and the network device side, which may be trained in advance by jointly training by a bilateral artificial intelligence (AI/ML) model, wherein the adaptation layer in the terminal equipment side is located behind the AI/ML model, which may be used to reduce a length of a bit sequence, so as to transform a first bit sequence into a second bit sequence (for example, different adaptation layer pairs may be trained for different bits). The adaptation layer at the network device side is located before the AI/ML reconstruction model, and the second bit sequence may be taken as input of the adaptation layer, so that a similarity between output of the AI/ML reconstruction model and input of the AI/ML model reaches a similarity that is not lower than a lower boundary. The information on the second model is, for example, information on an adaptation layer model, such as adaptation layer model #4.

The changing the configuration of the codebook of the first model may be, for example, changing a configuration parameter, wherein the codebook of the first model may be any of the following codebooks: a Type I codebook, a Type II codebook, an enhanced Type II codebook, a further enhanced Type II port selection codebook, and an enhanced codebook subsequent specified in 3GPP. The second model may be a same type of codebook under new configuration information, and the information on the second model may be information on the configuration of the codebook, such as a code number parameter paramCombination-r16=1.

In addition, in the case where the terminal equipment changes the first model to obtain the second model, the terminal equipment may transmit third information to the network device, the third information being used to report a method for obtaining the second model by the terminal equipment, the method including:
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.

In some other embodiments, the method for obtaining the second model by the terminal equipment may be: selecting a model from at least one candidate model and taking it as the second model. Furthermore, the terminal equipment may transmit information on the selected model to the network device

The at least one candidate model is configured by the network device by transmitting the first configuration information (e.g. the first configuration information may be included in CSI reporting configuration described below), and/or is agreed upon by the terminal equipment and the network device, and/or is determined by the terminal equipment, and/or is specified in a protocol. For example, in the at least one candidate model, some are configured by the network device, some are agreed upon by the network device and the terminal equipment, some are selected by the terminal equipment, and some are specified in a protocol.

In the case where the at least one candidate model is determined by the terminal equipment, the terminal equipment may receive second configuration information transmitted by the network device, the second configuration information indicating that the terminal equipment determines the at least one candidate model.

In some embodiments, the at least one candidate model is stored in the terminal equipment, and/or is trained and/or adjusted by the terminal equipment and/or the network device, and/or is transmitted to the terminal equipment by the network device, and/or is downloaded from a public server and/or a server possessing an intellectual property.

In at least one embodiment, the terminal equipment may further receive CSI reporting configuration transmitted by the network device, the CSI reporting configuration being used to configure changing the first model for the terminal equipment, so as to obtain a method of the second model and/or information on candidate models.

For example, the method for obtaining the second model configured for the terminal equipment by the CSI reporting configuration may be: changing the artificial intelligence model of the first model; and/or, changing the quantizer model of the first model; and/or, adding an adaptation layer to the first model, or reducing or changing the adaptation layer of the first model; and/or, changing the configuration of the codebook of the first model.

For another example, the information on the candidate models included in the CSI reporting configuration may be information on the above at least one candidate model. For example, the above first configuration information may be included in the CSI reporting configuration.

As shown in FIG. 3, in some embodiments, the channel state information transmission method further includes:
operation 303: the terminal equipment receives first indication information transmitted by the network device, the first indication information being used to indicate whether the terminal equipment is allowed to change a model for generating CSI.

In a case where the first indication information allows the terminal equipment to change a model for generating CSI, in operation 301, when it is determined that at least a part of the first CSI needs to be omitted, the terminal equipment uses the second model to generate first information of second CSI.

The embodiment of the first aspect shall be described below by way of examples.

### Example 1

In Example 1, the priority order of part 2 of the CSI is given in Table 2 and Table 3. The terminal equipment receives the configuration information transmitted by the network device, the configuration information including the CSI reporting configuration, the CSI reporting configuration including the method for obtaining the second model as “changing the artificial intelligence model (AI/ML model) of the first model”, and the CSI reporting configuration further including the information on the candidate models (for example, the candidate models may be AI/ML models).

In Table 2, the terminal equipment may determine a transmission layer needing CSI omission in a descending order of values of priority levels. A method of omission is generating the first information by using an AI/ML model (i.e. the second model) different from the first AI/ML model (i.e. the first model) for a layer needing to be omitted according to the priority order. The first information includes at least a part of information of information on the AI/ML-based precoding matrix, the LI and the CQI. The first AI/ML model generates CSI that needs to be omitted of the layer needing to be omitted. A bitwidth of the first information does not exceed a difference between a bitwidth output by the first AI/ML model and the number of bits of the transmission layer needing to be omitted.

For example, for the case in Table 2, there are four transmission layers. Bitwidths outputted by first models of the first, second, third and fourth transmission layers are 120 bits, 100 bits, 80 bits and 80 bits, respectively, that is, a sum of bitwidths outputted by the first models of all the layers is 380 bits. For CSI report 3, a₉=120, a₁₀=80, a₁₁=60, a₁₂=40. Uplink resources available for all the layers of CSI report 3 are less than 380 bits, which are assumed to be 330 bits, and are 50 bits less than the sum of bitwidths outputted by the first models of all the layers. The CSI report uses the CSI priority order given in column “#1” in Table 2. In an implementation in an existing mode, CSI priority level 23 and CSI priority level 24 are omitted. In this embodiment, CSI priority order 24 (40 bits) is unable to be reported, 10 bits in CSI priority order level 23 are unable to be reported, and total 110 bits in layer 3 and layer 4 are available. At most 70 bits in layer 3 may only be reported, and the number of bits in transmission layer 4 that may be reported is related to the number of bits in transmission layer 3 that are actually reported. For example, there are 12 AI/ML models available for the terminal equipment (needing 4 bits to describe), the terminal equipment selects AI/ML model #6 as the second model, and inputs channel information of transmission layers 3 and 4 into AI/ML model #6 to obtain output of 60 bits, respectively. For part 2 of CSI report 3, the terminal equipment reports the following information to the network device:
information on the AI/ML models of layer 3 and layer 4, such as AI/ML model #6, wherein as 4 bits are respectively needed by layer 3 and layer 4 to describe, 8 bits are needed (there are still 110−8=102 bits available for layer 3 and layer 4);
the CSI of layer 1 and layer 2, and other content that should be reported (if any);
output of AI/ML model #6 of layer 3, which is 60 bits (there are still 102−60=42 bits available for layer 3 and layer 4); and
former 42 bits of the output of AI/ML model #6 of layer 4.

After receiving the report from the terminal equipment, the network device learns according to contents of the report that the AI/ML models of layer 3 and layer 4 are replaced. As the network device knows a total number of bits of the CSI report before omission, according to the number of received bits of the CSI report and information on the replaced AI/ML models of layer 3 and layer 4, the network device learns that 18 bits of the CSI of layer 4 are omitted. According to a standard regulation or a pre-agreement, the network device may add 18 “1s” (or may add 18 “0s”) after a last bit of the CSI of layer 4 received by the network device. The network device replaces AI/ML reconstruction models of layer 3 and layer 4 according to the reported information on the replaced AI/ML models of layer 3 and layer 4, and recovers channel information.

For another example, there are total 8 AI/ML models available for the terminal equipment (needing 3 bits to describe). According to regulations in standards, for each transmission layer with omitted CSI, the terminal equipment selects an AI/ML model not exceeding an allowable maximum value of a bitwidth after omission, and reports it to the network device. The terminal equipment may select AI/ML model #2 for the transmission layer 3, an outputted bitwidth of which being 65 bits, and select AI/ML model #1 for the transmission layer 4, an outputted bitwidth of which being 40 bits. The terminal equipment inputs the channel information of transmission layer 3 into AI/ML model #2 and obtains an output of 65 bits. And the terminal equipment inputs the channel information of transmission layer 4 into AI/ML model #1 and obtains an output of 40 bits.

For part 2 of CSI report 3, the terminal equipment reports the following information to the network device:
information on the AI/ML model of layer 3, such as AI/ML model #2, which needs 3 bits to describe (there are still 110−3=107 bits available for layer 3 and layer 4);
information on the AI/ML model of layer 4, such as AI/ML model #1, which needs 3 bits to describe (there are still 107−3=104 bits available for layer 3 and layer 4);
CSI of layer 1 and layer 2, and other content that should be reported (if any);
output of AI/ML model #2 of layer 3, which is 65 bits (there are still 104−65=39 bits available for layer 3 and layer 4); and latter 39 bits of the output (fourth information) of the AI/ML model of layer 4.

After receiving the report from the terminal equipment, the network device learns according to contents of the report that the AI/ML models of layer 3 and layer 4 are replaced. As the network device knows a total number of bits of the CSI report before omission, according to the number of received bits of the CSI report and information on the replaced AI/ML models of layer 3 and layer 4, the network device learns that 1 bit of the CSI of layer 4 is omitted. According to a standard regulation, the network device may add a “0” before a first bit of the CSI of layer 4 received by the network device. The network device replaces AI/ML reconstruction models of layer 3 and layer 4 according to the reported information on the replaced AI/ML models of layer 3 and layer 4, and recovers channel information.

### Example 2

The priority order levels of the priority order of part 2 of the CSI are given in Table 2 and Table 3. The terminal equipment receives the configuration information transmitted by the network device, the configuration information including the CSI reporting configuration, the CSI reporting configuration including the method for obtaining the second model as “changing the quantizer model”. Information on optional quantizer models (i.e. candidate models) is specified in standards. In Table 3, the terminal equipment may determine a transmission layer needing CSI omission in a descending order of values of priority order levels. A method of omission is generating the first information of the CSI by using an AI/ML model for a transmission layer needing CSI omission according to the priority order. A preprocessing module (if any) and an AI/ML encoder in the AI/ML model are unchanged, and only the quantizer is changed. A bitwidth of the first information of the second CSI does not exceed a difference between a bitwidth output by the first AI/ML model and the number of bits of the layer needing to be omitted. The first AI/ML model generates CSI needing CSI omission of the layer needing to be omitted.

For example, for the case in Table 3, there are four transmission layers. Bitwidths outputted by first AI/ML models of the first, second, third and fourth transmission layers are 110 bits, 110 bits, 85 bits and 70 bits, respectively, that is, a sum of bitwidths outputted by the first AI/ML models of all the layers is 375 bits. For CSI report 3, a₉=100, a₁₀=95, a₁₁=75, a₁₂=50. Uplink resources available for all the layers of CSI report 3 are less than 375 bits, which are assumed to be 340 bits, and are 35 bits less than the sum of bitwidths outputted by the first AI/ML models of all the layers. The CSI report uses the CSI priority order given in column “#1” in Table 3. In an implementation in the related art, CSI priority level 19, CSI priority level 20 and CSI priority level 21 are omitted. In this disclosure, 20 bits in CSI priority order 21 are unable to be reported, 10 bits in CSI priority order level 20 are unable to be reported, 5 bits in CSI priority order level 19 are unable to be reported, and total 120 bits in layer 3 and layer 4 are available. At most 75 bits in layer 3 may only be reported, and the number of bits in transmission layer 4 that may be reported is related to the number of bits in transmission layer 3 that are actually reported. For example, there are total 20 quantizers available (needing 5 bits to describe). For the AI/ML model of transmission layer 3, the terminal equipment keeps a preprocessing module (if any) unchanged and the AI/ML encoder unchanged, and selects a quantizer of scalar quantization with a precision of 3 bits to obtain a second AI/ML model (i.e. the second model). The terminal equipment inputs channel information of transmission layer 3 into the second AI/ML model to obtain output of 75 bits. The terminal equipment selects quantizer model #1, and inputs channel information of transmission layer 4 into the quantizer model #1 to obtain output of 32 bits. For part 2 of CSI of CSI report 3, the terminal equipment reports the following information to the network device:
information on the quantizer of layer 3, such as a quantizer of scalar quantization with a precision of 3 bits and/or information on the second AI/ML model, which needs 5 bits to describe (there are still 120-5 =115 bits available for layer 3 and layer 4);
information on the AI/ML model of layer 4, such as the quantizer model #1, which needs 5 bits to describe (there are still 115−5=110 bits available for layer 3 and layer 4);
CSI of layer 1 and layer 2, and other content that should be reported (if any);
output of the second AI/ML model of layer 3, which is 75 bits (there are still 110−75=35 bits available for layer 3 and layer 4); and
output of AI/ML model #1 of layer 4, which is 32 bits.

After receiving the report from the terminal equipment, the network device learns according to contents of the report that the quantizers of layer 3 and layer 4 are replaced. The network device recovers channel information for dequantizers of the AI/ML reconstruction models of layer 3 and layer 4.

### Example 3

The priority order of part 2 of the CSI is given in Table 2 and Table 3. The terminal equipment receives the configuration information transmitted by the network device, the configuration information including the CSI reporting configuration, the CSI reporting configuration including the method for obtaining the second model as “adding an adaptation layer”, and further including information on optional adaptation layer models (i.e. candidate models). In Table 3, the terminal equipment may determine a transmission layer needing CSI omission in a descending order of values of priority order levels. A method of omission is adding an appropriate adaptation layer to a layer needing omission after the first AI/ML model to generate the first information of the second CSI, the first information including at least a part of information of information on the AI/ML-based precoding matrix, the LI and the CQI. The first AI/ML model generates CSI that needs to be omitted of the layer needing to be omitted, that is, at least a part of the CSI (for example, it is needed to omit the at least a part) is generated based on the first model. A bitwidth of the first information does not exceed a difference between a bitwidth output by the first AI/ML model and the number of bits of the layer needing to be omitted.

For example, for the case in Table 3, there are four transmission layers. Bitwidths outputted by first AI/ML models of the first, second, third and fourth transmission layers are 110 bits, 110bits, 85 bits and 70 bits, respectively, that is, a sum of bitwidths outputted by the first AI/ML models of all the layers is 375 bits. For CSI report 3, a₉=100, a₁₀=95, a₁₁=75, a₁₂=50. Uplink resources available for all the layers of CSI report 3 are less than 375 bits, which are assumed to be 340 bits, and are 35 bits less than the sum of bitwidths outputted by the first AI/ML models of all the layers.

The CSI report uses the CSI priority order given in column “#1” in Table 3. In an embodiment in the related art, CSI priority level 19, CSI priority level 20 and CSI priority level 21 are omitted. In this embodiment, 20 bits in CSI priority order 21 are unable to be reported, 10 bits in CSI priority order level 20 are unable to be reported, 5 bits in CSI priority order level 19 are unable to be reported, and total 120 bits in layer 3 and layer 4 are available. At most 75 bits in layer 3 may only be reported, and the number of bits in transmission layer 4 that may be reported is related to the number of bits in transmission layer 3 that are actually reported. For example, there are total 15 adaptation layers (needing 4 bits to describe) available for the terminal equipment. For transmission layer 3, the terminal equipment selects adaptation layer model #6, and serial connection of the AI/ML model of transmission layer 3 and the adaptation layer model #6 is referred to as a second model of transmission layer 3, with its output being defined as first information of the second CSI of transmission layer 3, and a bitwidth being 72 bits. For transmission layer 4, the terminal equipment selects adaptation layer model #14, and serial connection of the AI/ML model of transmission layer 4 and the adaptation layer model #14 is referred to as a second model of transmission layer 4, with its output being defined as first information of the second CSI of transmission layer 4, and a bitwidth being 39 bits. The terminal equipment inputs the channel information of transmission layer 3 into the second model of transmission layer 3 to obtain an output of 72 bits. The terminal equipment inputs the channel information of transmission layer 4 into the second model of transmission layer 4 to obtain an output of 39 bits. For part 2 of CSI report 3, the terminal equipment reports the following information to the network device:
information on the adaptation layer of layer 3, such as adaptation layer model #6, which needs 3 bits to describe (there are still 120−3=117 bits available for layer 3 and layer 4);
information on the adaptation layer of layer 4, such as adaptation layer model #14, which needs 3 bits to describe (there are still 117−3=114 bits available for layer 3 and layer 4);
CSI of layer 1 and layer 2, and other content that should be reported (if any);
output of the second model of layer 3, which is 75 bits (there are still 114−75=39 bits available for layer 3 and layer 4); and output of the second model of layer 4, which is 39 bits.

After receiving the report from the terminal equipment, the network device learns according to contents of the report that adapters are used for layer 3 and layer 4. The network device connects paired adapters in series in front of the AI/ML reconstruction models of layer 3 and layer 4 to recover channel information.

### Example 4

The priority order of part 2 of the CSI is given in Table 1 (for example, Table 1 is from 3GPP TS38.214 V17.4.0). The terminal equipment receives the configuration information transmitted by the network device, the configuration information including the CSI reporting configuration, the CSI reporting configuration including the method for obtaining the second model as “changing configuration of a codebook”.

The terminal equipment selects appropriate codebook parameters according to available uplink resources, so that a bitwidth of the fed back precoding matrix indication (PMI) does not exceed uplink resources available for transmitting the PMI. For example, for a codebook of enhanced Type II, the terminal equipment changes a value of a codebook paramCombination-r16 (such as changing the value of the parameter from 4 to 2), so that a bitwidth of the newly-generated PMI (i.e. the changed PMI is the first information of the second CSI) does not exceed the uplink resources available for transmitting the PMI. The terminal equipment reports paramCombination-r16 =2 and the newly-generated PMI to the network device.

After receiving the report from the terminal equipment, the network device learns the new codebook parameter according to contents of the report, and may recover channel information according to the received PMI.

### Example 5:

In some embodiments, the CSI reporting configuration further includes that the network device instructs the terminal equipment to report third information, the third information including the method used by the terminal equipment to obtain the second model. The terminal equipment selects a method for obtaining the second model, obtains one or more second models, and generates the first information of the second CSI. The terminal equipment transmits the second CSI, the third information and the information on the second model to the network device.

The priority order of part 2 of the CSI may be given, for example, in Table 2 or Table 3. The terminal equipment receives configuration information transmitted by the network device, the configuration information including the above CSI reporting configuration. The CSI reporting configuration includes information on optional AI/ML models, information on optional quantizer models, and information on optional adaptation layer models, wherein the optional AI/ML models, optional quantizer models and optional adaptation layer models are collectively referred to as candidate models.

The method selected by the terminal equipment for obtaining the second model is “changing an AI/ML model (that is, changing the AI model of the first model)”. As there are four types of AI models changing the first model, 2 bits are needed to describe the AI model changing the first model. In Table 2, the terminal equipment may determine a transmission layer needing CSI omission in a descending order of values of priority order levels. A method for omitting is using an AI/ML model different from the first AI/ML model (i.e. the first model) to generate the first information of the second CSI for the layer needing omission according to the priority order. The first information includes at least a part of information of information on the AI/ML-based precoding matrix, the LI and the CQI. The first AI/ML model generates CSI that needs to be omitted of the layer needing to be omitted, that is, at least a part of the CSI is generated based on the first model. The bitwidth of the first information does not exceed a difference between a bitwidth outputted by the first AI/ML model and the number of bits that the layer needs to omit. For example, for the case in Table 2, there are four transmission layers. Bitwidths outputted by first AI/ML models of the first, second, third and fourth transmission layers are 120 bits, 100 bits, 80 bits and 80 bits, respectively, that is, a sum of bitwidths outputted by the first AI/ML models of all the layers is 380 bits. For CSI report 3, a₉=120, a₁₀=80, a₁₁=60, a₁₂=40. Uplink resources available for all the layers of CSI report 3 are less than 380 bits, which are assumed to be 330 bits, and are 50 bits less than the sum of bitwidths outputted by the first AI/ML models of all the layers. The CSI report uses the CSI priority order given in column “#1” in Table 2. In the related art, CSI priority level 23 and CSI priority level 24 are omitted. In this embodiment, CSI priority order 24 (40 bits) is unable to be reported, 10 bits in CSI priority order level 23 are unable to be reported, and total 110 bits in layer 3 and layer 4 are available. At most 70 bits in layer 3 may only be reported, and the number of bits in transmission layer 4 that may be reported is related to the number of bits in transmission layer 3 that are actually reported. For example, there are 12 AI/ML models available for the terminal equipment (needing 4 bits to describe), the terminal equipment selects AI/ML model #6, and inputs channel information of transmission layers 3 and 4 into AI/ML model #6 to obtain output of 60 bits, respectively. For part 2 of CSI report 3, the terminal equipment reports the following information to the network device:
“changing the AI model of the first model” of the method for obtaining the second model selected by the terminal equipment, which needs 2 bits to describe the method for obtaining the second model (there are still 110−2=108 bits available for layer 3 and layer 4);
information on the AI/ML model (i.e. the second model) of layer 3 and layer 4, such as AI/ML model #6, which needs 4 bits to describe for layer 3 and layer 4 respectively, hence, 8 bits are needed ((there are still 108−8=100 bits available for layer 3 and layer 4);
the CSI of layer 1 and layer 2, and other content that should be reported (if any);
output of AI/ML model #6 of layer 3 (i.e. the first information of the second CSI), which is 60 bits (there are still 100−60=40 bits available for layer 3 and layer 4); and
former 40 bits of the output of AI/ML model #6 of layer 4 (i.e. the first information of the second CSI).

After receiving the report from the terminal equipment, the network device learns according to contents of the report that the method selected by the terminal equipment to obtain the second model is “changing the AI model of the first model”, and learns that AI/ML models are replaced for layer 3 and layer 4. As the network device knows a total number of bits of the CSI report before omission, according to the number of received bits of the CSI report and information on the replaced AI/ML models (i.e. the replaced AI/ML models are second models) of layer 3 and layer 4, the network device learns that 20 bits of the CSI of layer 4 are omitted. According to a standard regulation, the network device may add 20 “Os” (which may not “0s”, but other predefined bit sequences, such as “1s”, or alternately set “0s” and “1s”) before a last bit of the CSI of layer 4 received by the network device. The network device replaces AI/ML reconstruction models of layer 3 and layer 4 according to the reported information on the replaced AI/ML models (i.e. the replaced AI/ML models are second models) of layer 3 and layer 4, and recovers channel information.

### Example 6

The CSI report configuration transmitted by the network device to the terminal equipment includes the first indication information, the first indication information indicating whether the terminal equipment is allowed to change a model for generating CSI.

In some embodiments, in the case where the first indication information indicates that the terminal equipment is allowed to change a model for generating CSI, when it is determined that at least part of the first CSI needs to be omitted, the terminal equipment uses the second model to generate the first information of the second CSI. For example, operations of the terminal equipment may be as described in examples 1 to 5 above.

In some other implementations, in the case where the first indication information indicates that the terminal equipment is allowed to change a model for generating CSI, the terminal equipment transmits CSI to the network device according to the related art, and if necessary, uses the related art to omit CSI.

The first indication information may be described by using 1 bit, for example, that the first indication information is “the terminal equipment is allowed to change a model for generating CSI” is described by using 0, and that the first indication information is “the terminal equipment is allowed to change a model for generating CSI” is described by using 1.

According to the embodiment of the first aspect of this disclosure, the available uplink resources are fully utilized. In addition, the output of the second model with relatively small bitwidth output is used to replace at least part of the first CSI needing to be omitted. Hence, performances of AI/ML-based CSI feedback may be improved with less signaling overhead and implementation complexity.

### Embodiments of a Second Aspect

The embodiments of the second aspect provide a channel state information (CSI) reception method, applicable to a network device, such as the network device 201 in FIG. 2. Contents in the embodiments of the second aspect identical to those in the embodiments of the first aspect may refer to the description in the embodiment of the first aspect, which shall not be repeated herein any further.

FIG. 4 is a schematic diagram of the channel state information (CSI) reception method of the second aspect of this disclosure. As shown in FIG. 4, the method includes:

operation 401: the network device receives information on a second model and/or second channel state information (CSI) transmitted by a terminal equipment, wherein in a case where it is determined that at least a part of first channel state information (CSI) needs to be omitted, the terminal equipment generates first information of the second CSI by using the second model, the at least a part of the first CSI being generated based on a first model.

In some embodiments, the first model is different from the second model.

In some embodiments, the second model is obtained based on an available uplink resource of the terminal equipment.

In some embodiments, the first information of the second CSI is generated based on using the second model for a transmission layer needing to be omitted, a bitwidth of the first information being not greater than a difference between a bitwidth outputted by the first model and the number of bits of the transmission layer needing to be omitted, wherein the first information includes precoding matrix information, and/or a layer indicator (LI), and/or at least a part of information of a channel quality indicator (CQI).

In some embodiments, a method for obtaining the second model by the terminal equipment includes:
changing an artificial intelligence model of the first model; and/or
changing a quantizer model of the first model; and/or
adding an adaptation layer to the first model, or reducing or changing an adaptation layer in the first model; and/or
changing configuration of a codebook of the first model.

In some embodiments, selecting the second model by the terminal equipment includes:
selecting a model from candidate models and taking the model as the second model by the terminal equipment, wherein at least one of the candidate models is configured by the network device by transmitting first configuration information, and/or is agreed between the terminal equipment and the network device, and/or is determined by the terminal equipment, and/or is specified in a protocol.

In some embodiments, the network device transmits second configuration information to the terminal equipment, the second configuration information indicating that the terminal equipment determines the candidate model.

In some embodiments, the candidate models are stored in the terminal equipment, and/or are obtained through training and/or adjustment by the terminal equipment and/or the network device, and/or are transmitted by the network device to the terminal equipment, and/or are downloaded by the terminal equipment from a public server and/or a server possessing an intellectual property.

In some embodiments, the information on the second model includes:
information on the artificial intelligence model of the second model; and/or
information on the quantizer model of the second model; and/or
information on the adaptation layer model of the second model; and/or
configuration information of the codebook of the second model.

In some embodiments, the network device transmits CSI reporting configuration to the terminal equipment, the CSI reporting configuration being used to configure the terminal equipment with a method for obtaining the second model. And furthermore, the CSI reporting configuration includes information on the candidate models.

In some embodiments, the network device receives third information transmitted by the terminal equipment, the third information being used to report that a method for obtaining the second model by the terminal equipment is as follows:
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.

In some embodiments, as shown in FIG. 4, the channel state information (CSI) reception method of the second aspect of this disclosure further includes:

operation 402: the network device transmits first indication information to the terminal equipment, the first indication information being used to indicate whether the terminal equipment is allowed to change a model for generating CSI,
wherein when the terminal equipment is allowed to change the model for generating CSI and in a case where it is determined that at least a part of the first CSI needs to be omitted, the terminal equipment generates the first information of the second CSI by using the second model.

### Embodiments of a Third Aspect

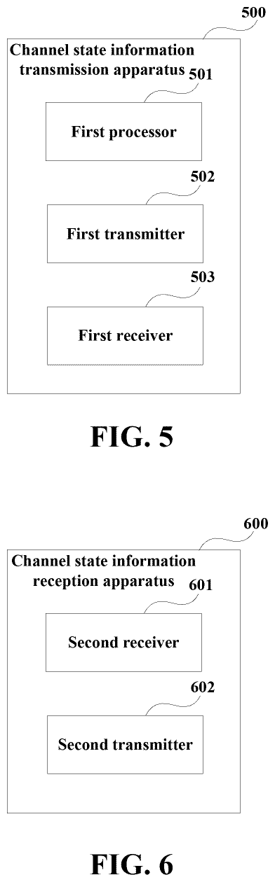

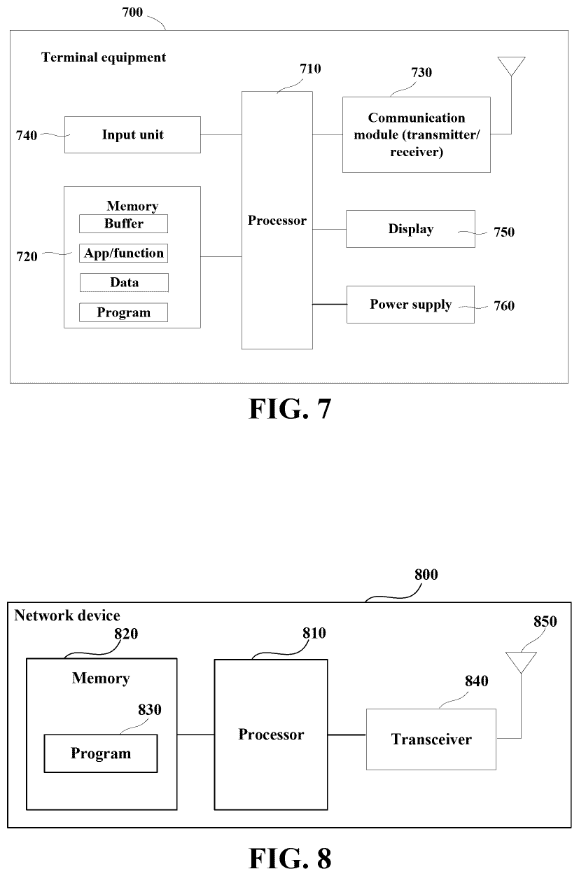

At least addressed to the same problem as the embodiment of the first aspect, the embodiments of the third aspect of this disclosure provide a channel state information transmission apparatus, applicable to a terminal equipment, and corresponding to the embodiments of the first aspect. FIG. 5 is a schematic diagram of the channel state information transmission apparatus of the third aspect of this disclosure. As shown in FIG. 7, a channel state information transmission apparatus 500 includes a first processor 501, a first transmitter 502 and a first receiver 503.

In some embodiments, the first processor 501 generates first information of second channel state information (CSI) by using a second model when the terminal equipment determines that at least a part of first CSI needs to be omitted, the at least a part of the first CSI being generated based on a first model; and the first transmitter 502 transmits the second CSI and/or information on the second model to a network device.

In some embodiments, the first model is different from the second model.

In some embodiments, the first processor 501 obtains the second model according to an available uplink resource.

In some embodiments, the second model is used for a transmission layer needing to be omitted to generate the first information of the second CSI, a bitwidth of the first information being not greater than a difference between a bitwidth outputted by the first model and the number of bits of the transmission layer needing to be omitted, wherein the first information includes precoding matrix information, and/or a layer indicator (LI), and/or at least a part of information of a channel quality indicator (CQI).

In some embodiments, a method for obtaining the second model includes:
changing an artificial intelligence model of the first model; and/or
changing a quantizer model of the first model; and/or
adding an adaptation layer to the first model, or reducing or changing an adaptation layer in the first model; and/or
changing configuration of a codebook of the first model.

In some embodiments, the selecting the second model includes:
selecting a model from candidate models and taking the model as the second model by the first processor 501, wherein at least one of the candidate models is configured by the network device by transmitting first configuration information, and/or is agreed between the terminal equipment and the network device, and/or is determined by the first processor, and/or is specified in a protocol.

In some embodiments, in a case where at least one of the candidate models is determined by the first processor 501, the first receiver 503 receives second configuration information transmitted by the network device, the second configuration information indicating that the first processor determines the candidate models.

The candidate models are stored in the terminal equipment, and/or are obtained through training and/or adjustment by the terminal equipment and/or the network device, and/or are transmitted by the network device to the terminal equipment, and/or are downloaded from a public server and/or a server possessing an intellectual property.

In some embodiments, the information on the second model includes:
information on the artificial intelligence model of the second model; and/or
information on the quantizer model of the second model; and/or
information on the adaptation layer model of the second model; and/or
configuration information of the codebook of the second model.

In some embodiments, the first receiver 503 receives CSI reporting configuration transmitted by the network device, the CSI reporting configuration being used to configure for the first processor with a method for obtaining the second model, wherein the CSI reporting configuration further includes information on the candidate models.

In some embodiments, the first transmitter 502 transmits third information to the network device, the third information being used to report that an apparatus for obtaining the second model by the terminal equipment is as follows:
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.

In some embodiments, the first receiver 503 receives first indication information transmitted by the network device, the first indication information being used to indicate whether the terminal equipment is allowed to change a model for generating CSI, and when the terminal equipment is allowed to change the model for generating CSI and in a case where it is determined that at least a part of the first CSI needs to be omitted, the first processor generates the first information of the second CSI by using the second model.

### Embodiments of a Fourth Aspect

The embodiments of the fourth aspect of this disclosure provide a channel state information reception apparatus, applicable to a network device, and corresponding to the embodiment of the first aspect.

FIG. 6 is a schematic diagram of the channel state information reception apparatus of the fourth aspect of this disclosure. As shown in FIG. 6, a channel state information reception apparatus 600 includes a second receiver 601 and a second transmitter 602.

In some embodiments, the second receiver 601 receives information on a second model and/or second channel state information (CSI) transmitted by a terminal equipment, wherein in a case where it is determined that at least a part of first channel state information (CSI) needs to be omitted, the terminal equipment generates first information of the second CSI by using the second model, the at least a part of the first CSI being generated based on a first model.

In some embodiments, the first model is different from the second model.

In some embodiments, the second model is obtained based on an available uplink resource of the terminal equipment.

In some embodiments, the first information of the second CSI is generated based on using the second model for a transmission layer needing to be omitted, a bitwidth of the first information being not greater than a difference between a bitwidth outputted by the first model and the number of bits of the transmission layer needing to be omitted.

In some embodiments, the first information includes precoding matrix information, and/or a layer indicator (LI), and/or at least a part of information of a channel quality indicator (CQI).

In some embodiments, a method for obtaining the second model by the terminal equipment includes:
changing an artificial intelligence model of the first model; and/or
changing a quantizer model of the first model; and/or
adding an adaptation layer to the first model, or reducing or changing an adaptation layer in the first model; and/or
changing configuration of a codebook of the first model.

In some embodiments, the selecting the second model by the terminal equipment includes: selecting a model from candidate models and taking the model as the second model by the terminal equipment, wherein at least one of the candidate models is configured by the network device by transmitting first configuration information, and/or is agreed between the terminal equipment and the network device, and/or is determined by the terminal equipment, and/or is specified in a protocol.

In some embodiments, the second transmitter 602 transmits second configuration information to the terminal equipment, the second configuration information indicating that the terminal equipment determines the candidate models.

In some embodiments, the candidate models are stored in the terminal equipment, and/or are obtained through training and/or adjustment by the terminal equipment and/or the network device, and/or are transmitted by the network device to the terminal equipment, and/or are downloaded by the terminal equipment from a public server and/or a server possessing an intellectual property.

In some embodiments, the information on the second model includes:
information on the artificial intelligence model of the second model; and/or
information on the quantizer model of the second model; and/or
information on the adaptation layer model of the second model; and/or
configuration information of the codebook of the second model.

In some embodiments, the second transmitter 602 transmits CSI reporting configuration to the terminal equipment, the CSI reporting configuration being used to configure the terminal equipment with a method for obtaining the second model, wherein the CSI reporting configuration further includes information on the candidate models.

In some embodiments, the second receiver 601 receives third information transmitted by the terminal equipment, the third information being used to report that an apparatus for obtaining the second model by the terminal equipment is as follows:
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.

In some embodiments, the second transmitter 602 transmits first indication information to the terminal equipment, the first indication information being used to indicate whether the terminal equipment is allowed to change a model for generating CSI;
and when the terminal equipment is allowed to change the model for generating CSI and in a case where it is determined that at least a part of the first CSI needs to be omitted, the terminal equipment generates the first information of the second CSI by using the second model.

### Embodiments of a Fifth Aspect

The embodiments of the fifth aspect of this disclosure provide a communication system, including a network device and a terminal equipment.

FIG. 7 is a schematic diagram of the terminal equipment of the embodiment of the fifth aspect of this disclosure. As shown in FIG. 7, a terminal equipment 700 (such as corresponding to the terminal equipment 202 in FIG. 2) may include a processor 710 and a memory 720, the memory 720 storing data and a program and being coupled to the processor 710. It should be noted that this figure is illustrative only, and other types of structures may also be used, so as to supplement or replace this structure and achieve a telecommunications function or other functions.

For example, the processor 710 may be configured to execute a program to carry out the method described in the embodiment of the first aspect.

As shown in FIG. 7, the terminal equipment 700 may further include a communication module 730, an input unit 740, a display 750, and a power supply 760, wherein functions of the above components are similar to those in the related art, which shall not be described herein any further. It should be noted that the terminal equipment 700 does not necessarily include all the parts shown in FIG. 7, and the above components are not necessary. Furthermore, the terminal equipment 700 may include parts not shown in FIG. 7, and the related art may be referred to.

FIG. 8 is a schematic diagram of the network device of the embodiment of the fifth aspect. As shown in FIG. 8, a network device 800 (such as corresponding to the network device 201 in FIG. 2) may include a processor 810 (such as a central processing unit (CPU) and a memory 820, the memory 820 being coupled to the processor 810. The memory 820 may store various data, and furthermore, it may store a program 830 for information processing, and execute the program under control of the processor 810.

For example, the processor 810 may be configured to execute a program to carry out the method described in the embodiment of the second aspect.

Furthermore, as shown in FIG. 8, the network device 800 may include a transceiver 840, and an antenna 850, etc. Functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

An embodiment of this disclosure provides a computer readable program, which, when executed in a terminal equipment, causes the terminal equipment to carry out the method as described in the embodiment of the first aspect.

An embodiment of this disclosure provides a computer storage medium, including a computer readable program, which causes a terminal equipment to carry out the method as described in the embodiment of the first aspect.

An embodiment of this disclosure provides a computer readable program, which, when executed in a network device, causes the network device to carry out the method as described in the embodiment of the second aspect.

An embodiment of this disclosure provides a computer storage medium, including a computer readable program, which causes a network device to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.

A method at a terminal side:
1. A channel state information transmission method, applicable to a terminal equipment, the method including:
generating first information of second channel state information (CSI) by using a second model when the terminal equipment determines that at least a part of first CSI needs to be omitted, the at least a part of the first CSI being generated based on a first model; and
transmitting the second CSI and/or information on the second model by the terminal equipment to a network device.
2. The method according to supplement 1, wherein,
the first model is different from the second model.
3. The method according to supplement 1, wherein,
the terminal equipment obtains the second model according to an available uplink resource.
4. The method according to supplement 1, wherein,
the second model is used for a transmission layer needing to be omitted to generate the first information of the second CSI, a bitwidth of the first information being not greater than a difference between a bitwidth outputted by the first model and the number of bits of the transmission layer needing to be omitted.
5. The method according to supplement 4, wherein,
the first information includes precoding matrix information, and/or a layer indicator (LI), and/or at least a part of information of a channel quality indicator (CQI).
6. The method according to supplement 1, wherein,
a method for obtaining the second model includes:
changing an artificial intelligence model of the first model; and/or
changing a quantizer model of the first model; and/or
adding an adaptation layer to the first model, or reducing or changing an adaptation layer in the first model; and/or
changing configuration of a codebook of the first model.
7. The method according to supplement 1, wherein,
selecting the second model includes:
selecting a model from candidate models and taking the model as the second model by the terminal equipment, wherein at least one of the candidate models is configured by the network device by transmitting first configuration information, and/or is agreed between the terminal equipment and the network device, and/or is determined by the terminal equipment, and/or is specified in a protocol.
8. The method according to supplement 7, wherein,
in a case where at least one of the candidate models is determined by the terminal equipment, the method further includes:
receiving, by the terminal equipment, second configuration information transmitted by the network device, the second configuration information indicating that the terminal equipment determines the candidate model.
9. The method according to supplement 7, wherein,
the candidate models are stored in the terminal equipment, and/or are obtained through training and/or adjustment by the terminal equipment and/or the network device, and/or are transmitted by the network device to the terminal equipment, and/or are downloaded from a public server and/or a server possessing an intellectual property.
10. The method according to supplement 1, wherein,
the information on the second model includes:
information on the artificial intelligence model of the second model; and/or
information on the quantizer model of the second model; and/or
information on the adaptation layer model of the second model; and/or
configuration information of the codebook of the second model.
11. The method according to supplement 6, wherein the method further includes:
receiving, by the terminal equipment, CSI reporting configuration transmitted by the network device, the CSI reporting configuration being used to configure the terminal equipment with a method for obtaining the second model.
12. The method according to supplement 11, wherein,
the CSI reporting configuration further includes information on the candidate models.
13. The method according to supplement 1, wherein the method further includes:
transmitting third information by the terminal equipment to the network device, the third information being used to report that a method for obtaining the second model by the terminal equipment is as follows:
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.
14. The method according to supplement 1, wherein the method further includes:
receiving, by the terminal equipment, first indication information transmitted by the network device, the first indication information being used to indicate whether the terminal equipment is allowed to change a model for generating CSI; and
when the terminal equipment is allowed to change the model for generating CSI and in a case where it is determined that at least a part of the first CSI needs to be omitted, generating the first information of the second CSI by the terminal equipment by using the second model.

A method at a network side:
1. A channel state information reception method, applicable to a network device, the method including:
receiving, by the network device, information on a second model and/or second channel state information (CSI) transmitted by a terminal equipment,
wherein in a case where it is determined that at least a part of first channel state information (CSI) needs to be omitted, the terminal equipment generates first information of the second CSI by using the second model, the at least a part of the first CSI being generated based on a first model.
2. The method according to supplement 1, wherein,
the first model is different from the second model.
3. The method according to supplement 1, wherein,
the second model is obtained based on an available uplink resource of the terminal equipment.
4. The method according to supplement 1, wherein,
the first information of the second CSI is generated based on using the second model for a transmission layer needing to be omitted, a bitwidth of the first information being not greater than a difference between a bitwidth outputted by the first model and the number of bits of the transmission layer needing to be omitted.
5. The method according to supplement 4, wherein,
the first information includes precoding matrix information, and/or a layer indicator (LI), and/or at least a part of information of a channel quality indicator (CQI).
6. The method according to supplement 1, wherein,
a method for obtaining the second model by the terminal equipment includes:
changing an artificial intelligence model of the first model; and/or
changing a quantizer model of the first model; and/or
adding an adaptation layer to the first model, or reducing or changing an adaptation layer in the first model; and/or
changing configuration of a codebook of the first model.
7. The method according to supplement 1, wherein,
selecting the second model by the terminal equipment includes:
selecting a model from candidate models and taking the model as the second model by the terminal equipment, wherein at least one of the candidate models is configured by the network device by transmitting first configuration information, and/or is agreed between the terminal equipment and the network device, and/or is determined by the terminal equipment, and/or is specified in a protocol.
8. The method according to supplement 7, wherein,
the method further includes:
transmitting second configuration information by the network device to the terminal equipment, the second configuration information indicating that the terminal equipment determines the candidate model.
9. The method according to supplement 7, wherein,
the candidate models are stored in the terminal equipment, and/or are obtained through training and/or adjustment by the terminal equipment and/or the network device, and/or are transmitted by the network device to the terminal equipment, and/or are downloaded by the terminal equipment from a public server and/or a server possessing an intellectual property.
10. The method according to supplement 1, wherein,
the information on the second model includes:
information on the artificial intelligence model of the second model; and/or
information on the quantizer model of the second model; and/or
information on the adaptation layer model of the second model; and/or
configuration information of the codebook of the second model.
11. The method according to supplement 6, wherein the method further includes:
transmitting CSI reporting configuration by the network device to the terminal equipment, the CSI reporting configuration being used to configure the terminal equipment with a method for obtaining the second model.
12. The method according to supplement 11, wherein,
the CSI reporting configuration further includes information on the candidate models.
13. The method according to supplement 1, wherein the method further includes:
receiving, by the network device, third information transmitted by the terminal equipment, the third information being used to report that a method for obtaining the second model by the terminal equipment is as follows:
changing the artificial intelligence model of the first model; and/or
changing the quantizer model of the first model; and/or
adding an adaptation layer to the first model, or reducing or changing the adaptation layer of the first model; and/or
changing the configuration of the codebook of the first model.
14. The method according to supplement 1, wherein the method further includes:
transmitting first indication information by the network device to the terminal equipment, the first indication information being used to indicate whether the terminal equipment is allowed to change a model for generating CSI; and
when the terminal equipment is allowed to change the model for generating CSI and in a case where it is determined that at least a part of the first CSI needs to be omitted, generating the first information of the second CSI by the terminal equipment by using the second model.

What is claimed is:

1. A channel state information transmission apparatus, applicable to a terminal equipment, the apparatus comprising:
processor circuitry configured to generate first information of second channel state information (CSI) by using a second model when the terminal equipment determines that at least a part of first CSI needs to be omitted, the at least a part of the first CSI being generated based on a first model; and
a first transmitter configured to transmit the second CSI and/or information on the second model to a network device.

2. The apparatus according to claim 1, wherein,
the processor circuitry obtains the second model according to an available uplink resource.

3. The apparatus according to claim 1, wherein,
the second model is used for a transmission layer needing to be omitted to generate the first information of the second CSI, a bitwidth of the first information being not greater than a difference between a bitwidth outputted by the first model and the number of bits of the transmission layer needing to be omitted.

4. The apparatus according to claim 1, wherein,
a method for obtaining the second model comprises:
changing an artificial intelligence model of the first model; and/or
changing a quantizer model of the first model; and/or
adding an adaptation layer to the first model, or reducing or changing an adaptation layer in the first model; and/or
changing configuration of a codebook of the first model.

5. The apparatus according to claim 1, wherein,
selecting the second model comprises:
selecting a model from candidate models and taking the model as the second model by the processor circuitry, wherein at least one of the candidate models is configured by the network device by transmitting first configuration information, and/or is agreed between the terminal equipment and the network device, and/or is determined by the processor circuitry, and/or is specified in a protocol.

6. The apparatus according to claim 5, wherein,
in a case where at least one of the candidate models is determined by the processor circuitry,
a first receiver of the apparatus receives second configuration information transmitted by the network device, the second configuration information indicating that the processor circuitry determines the candidate models.

7. The apparatus according to claim 4, wherein,
a first receiver of the apparatus receives CSI reporting configuration transmitted by the network device, the CSI reporting configuration being used to configure for the processor circuitry with a method for obtaining the second model.

8. The apparatus according to claim 7, wherein,
the CSI reporting configuration further comprises information on candidate models.

9. The apparatus according to claim 1, wherein the apparatus further comprises:
the first transmitter transmits third information to the network device, the third information being used to report that a method for obtaining the second model by the terminal equipment is as follows:
changing the artificial intelligence model of the first model; and/or changing the quantizer model of the first model; and/or
adding an adaptation layer to the first model, or reducing or changing the adaptation layer of the first model; and/or
changing the configuration of the codebook of the first model.

10. The apparatus according to claim 1, wherein,
a first receiver of the apparatus receives first indication information transmitted by the network device, the first indication information being used to indicate whether the terminal equipment is allowed to change a model for generating CSI;
and when the terminal equipment is allowed to change the model for generating CSI and in a case where it is determined that at least a part of the first CSI needs to be omitted, the processor circuitry generates the first information of the second CSI by using the second model.

11. A channel state information reception apparatus, applicable to a network device, the apparatus comprising:
a second receiver configured to receive information on a second model and/or second channel state information (CSI) transmitted by a terminal equipment,
wherein in a case where it is determined that at least a part of first channel state information (CSI) needs to be omitted, the terminal equipment generates first information of the second CSI by using the second model, the at least a part of the first CSI being generated based on a first model.

12. The apparatus according to claim 11, wherein,
the second model is obtained based on an available uplink resource of the terminal equipment.

13. The apparatus according to claim 11, wherein,
the first information of the second CSI is generated based on using the second model for a transmission layer needing to be omitted, a bitwidth of the first information being not greater than a difference between a bitwidth outputted by the first model and the number of bits of the transmission layer needing to be omitted.

14. The apparatus according to claim 11, wherein,
a method for obtaining the second model by the terminal equipment comprises:
changing an artificial intelligence model of the first model; and/or changing a quantizer model of the first model; and/or
adding an adaptation layer to the first model, or reducing or changing an adaptation layer in the first model; and/or
changing configuration of a codebook of the first model.

15. The apparatus according to claim 11, wherein,
selecting the second model by the terminal equipment comprises:
selecting a model from candidate models and taking the model as the second model by the terminal equipment, wherein at least one of the candidate models is configured by the network device by transmitting first configuration information, and/or is agreed between the terminal equipment and the network device, and/or is determined by the terminal equipment, and/or is specified in a protocol.

16. The apparatus according to claim 15, wherein,
a second transmitter of the apparatus transmits second configuration information to the terminal equipment, the second configuration information indicating that the terminal equipment determines the candidate models.

17. The apparatus according to claim 11, wherein,
the information on the second model comprises:
information on the artificial intelligence model of the second model; and/or
information on the quantizer model of the second model; and/or
information on the adaptation layer model of the second model; and/or
configuration information of the codebook of the second model.

18. The apparatus according to claim 14, wherein,
a second transmitter of the apparatus transmits CSI reporting configuration to the terminal equipment, the CSI reporting configuration being used to configure the terminal equipment with a method for obtaining the second model.

19. The apparatus according to claim 11, wherein,
the second receiver receives third information transmitted by the terminal equipment, the third information being used to report that a method for obtaining the second model by the terminal equipment is as follows:
changing the artificial intelligence model of the first model; and/or
changing the quantizer model of the first model; and/or
adding an adaptation layer to the first model, or reducing or changing the adaptation layer of the first model; and/or changing the configuration of the codebook of the first model.

20. The apparatus according to claim 11, wherein,
a second transmitter of the apparatus transmits first indication information to the terminal equipment, the first indication information being used to indicate whether the terminal equipment is allowed to change a model for generating CSI;
and when the terminal equipment is allowed to change the model for generating CSI and in a case where it is determined that at least a part of the first CSI needs to be omitted, the terminal equipment generates the first information of the second CSI by using the second model.
